(19) United States
(12) Patent Application Publication
(10) Pub. No.: US 2015/0014437 A1
(43) Pub. Date: Jan. 15, 2015

(54) AIR IMPINGEMENT NOZZLE

(71) Applicant: Marel Meat Processing Inc., Des Moines, IA (US)

(72) Inventor: Gary H. Anders, Des Moines, IA (US)

(21) Appl. No.: 14/302,766

(22) Filed: Jun. 12, 2014

Related U.S. Application Data
(60) Provisional application No. 61/845,640, filed on Jul. 12, 2013.

(51) Int. Cl. A47J 36/00; B05B 1/34

(52) U.S. Cl. CPC A47J 36/00; B05B 1/341
USPC 239/124

(57) ABSTRACT

An air impingement nozzle that includes a fluid supply line with a fluid inlet and a fluid return line with a fluid outlet. A first wall in spaced walls extend between and are in communication with the fluid inlet and the fluid outlet to form a fluid channel. The first wall and second wall are curved such that an outer surface of the first and second wall form an air nozzle.

### CROSS REFERENCE TO RELATED APPLICATION

This application claims the benefit of U.S. Provisional Application No. 61/845,640 filed Jul. 12, 2013.

### BACKGROUND OF THE INVENTION

This invention is directed to an impingement nozzle and more particularly an impingement nozzle for improving the flow of liquids and gases for cooking food products.

Commercial spiral ovens are generally ovens with product sitting on wide conveyor belts that are closely spaced for heating efficiency. Typically, food product enters the spiral at the bottom of the oven and ascends slowly to the top where once cooked the food product exits the oven and moves to the next process. As the food product moves through the oven, the food product is cooked as heat is directed over the food product.

An important aspect of the cooking process is that initially there is a blanket of secondary air surrounding the food product. The secondary air is cooler and moister because the product is not yet at the set point of the oven. Current cooking methods generally use cross-flow technology where heated air is blown parallel to the product and does not penetrate the layer of secondary air surrounding the food product. Alternatively, impingement technology, which provides the highest level of heat transfer to the target product, directs heated air in a focused manner onto the surface of the food product, penetrating the layer of secondary air. Both technologies require a cold air return of some type to draw the air through and around the food product, creating an air loop. The air loop must be balanced in order for the oven to work correctly.

The advantage of impingement technology is that it forces air onto the surface of the food product displacing the layer of secondary air that surrounds the product as compared to cross-flow technology which permits the mixing of primary set point air with secondary air resulting in slower heat transfer and less browning. With cross-flow technology, more of the moisture in the food product turns to steam which reduces the amount of browning.

Current ovens using impingement technology have limitations on the efficiency of providing impingement air. Air, like other fluids, needs to be straightened so that the air is moving in exactly the same direction. For peak efficiency, there is an ideal focal length of the air channel which depends upon the volume and speed of the air flow required. Obtaining an ideal focal length is difficult if not impossible due to the confined space between rows of belting. As an example, an ideal focal length is 5 to 8 times the diameter of the nozzle. Less length provides less than ideal calumniated air flow.

Another shortcoming of current impingement technology is that tubes used to convey air are difficult to clean. Ovens of this type have hundreds of tubes positioned above and below the product and the cleaning process is time consuming.

Therefore, there is a need for an improved air impingement nozzle that addresses these deficiencies.

An object of the present invention is to provide an impingement nozzle that has the ability to columnize air flow from the nozzle.

A further objective of the present invention is to provide an impingement nozzle having a balanced air flow across and within a five percent of a treatment zone and provide a balanced return to a fan equal to the supply volume.

A still further objective is to provide an impingement nozzle that is easily cleanable and sanitary.

Yet another objective is to provide an impingement nozzle that can fit within a headspace above the product treatment zone and provide air flow from both above and below a product belt.

### SUMMARY OF THE INVENTION

An air impingement nozzle that includes a fluid supply line with a fluid inlet and a fluid return line with a fluid outlet. A first wall in spaced walls extend between and are in communication with the fluid inlet and the fluid outlet to form a fluid channel. The first wall and second wall are curved such that an outer surface of the first and second wall form an air nozzle.

In another embodiment, an impingement nozzle has an arcuate first wall having a first end and a second end that are spaced to create an opening. A second wall is disposed within the first wall and is formed to create a supply plenum and dual air nozzles.

### BRIEF DESCRIPTION OF THE FIGURES

FIG. 1 is a side sectional view of an air impingement;

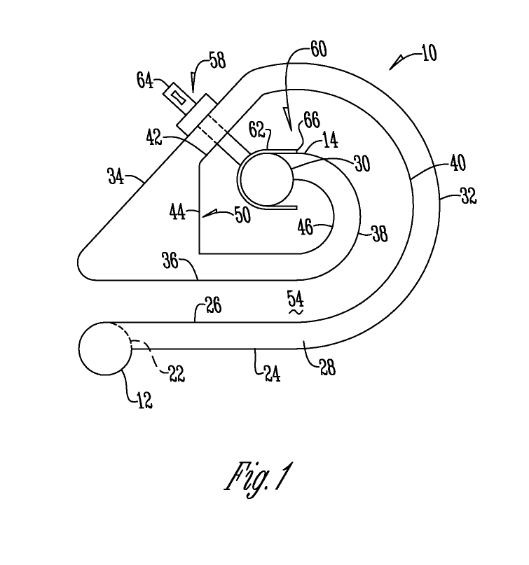

FIG. 2 is a perspective view of an air impingement nozzle;

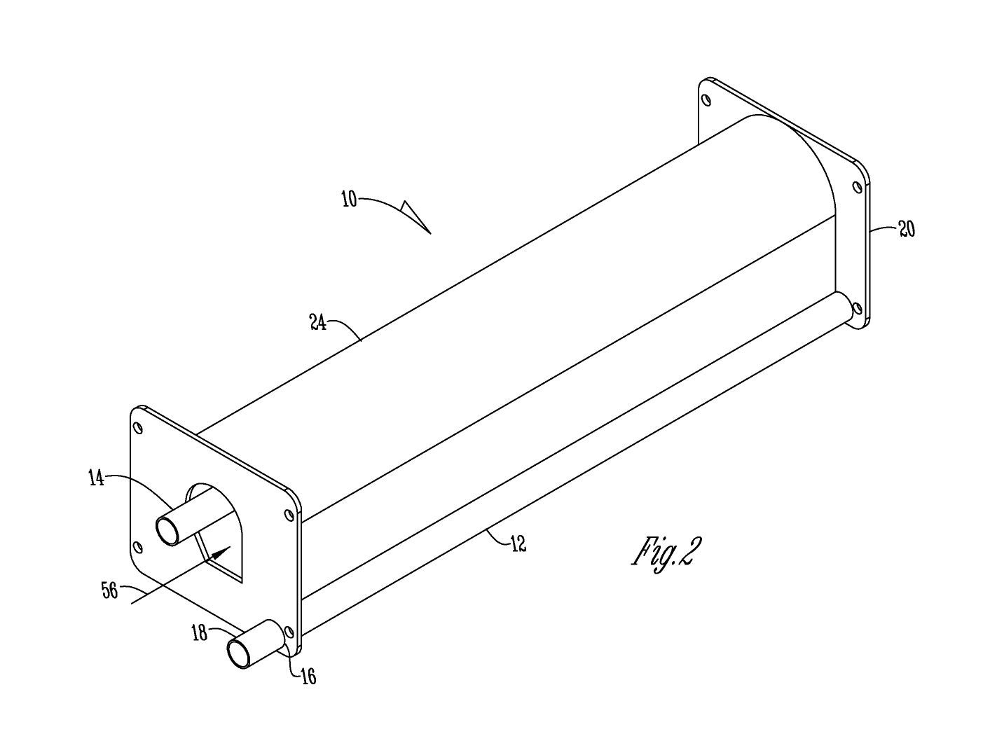

FIG. 3 is a perspective view of an air impingement nozzle assembly; and

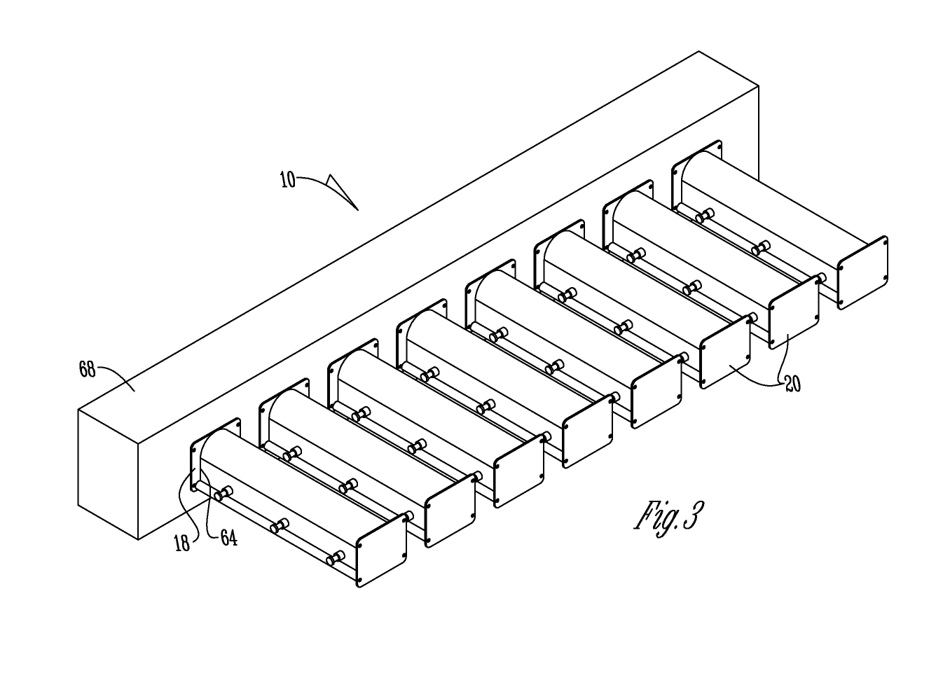

FIG. 4 is an end view of an air impingement nozzle.

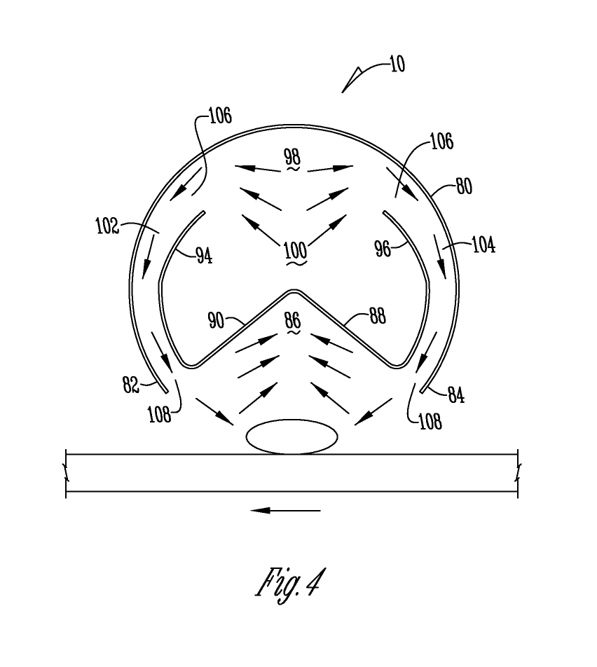

### DETAILED DESCRIPTION OF THE PREFERRED EMBODIMENTS

An air impingement nozzle 10 has a thermal oil supply line 12 and a thermal oil return line 14. The thermal oil supply line 12 extends through an opening 16 in a first mounting plate 18 and extends to and is connected to a second mounting plate 20. Extending from a fluid supply port or inlet 22 of supply line 12 is a first and second wall 24 and 26 that form a thermal oil channel 28 that terminates at a thermal fluid outlet exhaust port 30 of the thermal oil return line 14.

Wall 24 extends linerally from supply line 12 to an arcuate portion 32, from an arcuate portion 32 to an angled portion 34, from an angled portion 34 to a second linear portion 36, from the second linear portion 36 to a second arcuate section 38 which terminates at port 30. Wall 26 extends literally in spaced relation to wall 24 from port 22 to an acruate section 40, from the actuate section 40 to an angled section 42, from the angled section 42 an L-shaped section 44, from the L-shaped section 44 to a second arcuate section 46 that terminate at port 30. The angled section 42, L-shaped section 44, and second arcuate section 46 which roll inwardly toward return line 14 from an air plenum 48 on a first surface 50 of wall 26. The same surface 50 of wall 26 from the first arcuate section 40 and linerally to port 22 forms an air channel or nozzle 54 with the second linear portion 36 and second arcuate portion 38 of wall 24. Thermal oil return line 14 is connected to and extends from second mounting plate 20 to first mounting plate 18 through an air plenum opening 56.

A choke bar assembly 58 is used to control the width of the nozzle 54 at the inlet 60 of the nozzle 54 to provide sufficient back flow pressure. The choke bar assembly 58 includes a choke bar 62 that is arcuate and fits partially around return line 14. Attached to the choke bar 62 are a plurality of knobs 64 that extend through walls 24 and 26 at angled sections 34 and 42. A first end 66 of the choke bar 62 extends into the inlet 60 of nozzle 54 such that the gap or opening at the inlet may be selectively adjusted.

The air impingement nozzle can be used in any application where straightening of a fluid (liquid or air) is required. In one embodiment, a plurality of nozzles 10 are connected to an air supply plenum 68. The nozzles 10 are bolted onto the supply plenum 68 which includes a fan 70 and a return plenum 72. Further, the supply line 12 and return line 14 are connected, using quick disconnected fittings in a closed fluid circuit with a pump.

In operation, thermal oil is pumped into supply line 12 and flows through inlet 22 to thermal oil channel 28 through exhaust port 30 and back through thermal oil return line 14. At the same time, air is blown through the air plenum opening 56 into the air plenum 48 where the air flows through nozzle 54 that provides an air wall of primary air to a product being transported on a belt. There is enough length in the nozzle 54 to provide back pressure to maintain balance flow as well as train the air stream. As the air flows through the plenum 48 and nozzle 54, it is heated by the thermal oil in channel 28.

In an alternative embodiment, the impingement nozzle 10 includes a first wall 80 that is acruate such that the ends 82 and 84 curve back toward one another and create an opening 86. Disposed within the first wall 80 is a second wall 88 that has a V-shaped portion 90 with a central point 92. The V-shaped portion terminates into arcuate sections 94 and 96 that curve back toward one another above the point 92 and create an opening 98. The V-shaped portion 90 and arcuate sections 94 and 96 form a supply plenum 100. The arcuate sections 94 and 96 of the second wall 88 in combination with the arcuate first wall 80 form dual air channels or nozzles 102 and 104. Preferably, the gap at the inlet 106 of the nozzles 102 and 104 is wider than the gap at the outlet 108.

In this embodiment, air is blown into supply plenum 100 and flows through opening 98. From opening 98, air flows through nozzles 102 and 104 creating a tandem flow that encompasses the product creating a swirling flow around the food product, thus maximizing heat transfer. The return flow is incorporated directly above the target area to maximize air change and keep the product surface at set point conditions.

What is claimed is:

1. An air impingement nozzle, comprising:
a fluid supply line having an inlet port;
a fluid return line having an outlet port;
a first wall in spaced relation to a second wall wherein the walls extend between and are in communication with the inlet port and the outlet port to form a fluid channel; and
the first wall and the second wall are curved such that an outer surface of the first wall and the second wall form an air nozzle.

2. The impingement nozzle of claim 1 wherein the outer surface of the second wall forms an air plenum with the fluid return line.

3. The impingement nozzle of claim 1 further comprising a choke bar assembly positioned at an inlet of the air nozzle.

4. The impingement nozzle of claim 3 wherein the choke bar assembly includes a choke bar that partially fits around the fluid return line and a plurality of knobs that extend through the first and second walls and are connected to the choke bar.

5. The impingement nozzle of claim 1 wherein the fluid supply line extends through an opening in a first mounting plate and is connected to a second mounting plate.

6. The impingement nozzle of claim 5 wherein the fluid return line is connected to and extends from the second mounting plate to the first mounting plate through an air plenum opening.

7. The impingement nozzle of claim 4 wherein an end of the choke bar extends into the inlet of the air nozzle to form a selectively adjustable gap.

8. An impingement nozzle, comprising:
an arcuate first wall having a first end and a second end that are spaced to create an opening; and
a second wall disposed within the first wall that is formed to create a supply plenum and dual air nozzles.

9. The impingement nozzle of claim 8 wherein the second wall has a V-shaped portion with a central point.

10. The impingement nozzle of claim 9 wherein the V-shaped portion terminates into arcuate sections that are spaced apart to create an opening.

11. The impingement nozzle of claim 10 wherein the V-shaped portion and arcuate sections form the supply plenum.

12. The impingement nozzle of claim 10 wherein the arcuate sections in combination with the arcuate first wall form the dual air nozzles.

13. The impingement nozzle of claim 1 wherein the dual air nozzles have an inlet and an outlet.

14. The impingement nozzle of claim 13 wherein a gap at the inlet of the air nozzles is wider than a gap at the outlet of the air nozzles.

15. The impingement nozzle of claim 13 wherein the dual air nozzles create a tandem swirling air flow around a food product.
